(19) United States
(12) Patent Application Publication
(10) Pub. No.: US 2013/0120203 A1
(43) Pub. Date: May 16, 2013

(54) Antenna Unit, Antenna Array and Antenna Module Used in a Portable Device

(71) Applicant: Ya Chung YU, Taipei City (TW)

(72) Inventor: Ya Chung YU, Taipei City (TW)

(73) Assignee: SJ ANTENNA DESIGN CORP., Taipei (TW)

(21) Appl. No.: 13/450,066

(22) Filed: Apr. 18, 2012

(30) Foreign Application Priority Data
Nov. 11, 2011 (TW) 100141302

(51) Int. Cl. H01Q 13/10

(52) U.S. Cl. 343/770

(57) ABSTRACT

An antenna unit used in a portable device is disclosed, comprising a body which has a feeding end, a radiant end, and two outer edges. The feeding end is configured to receive an input signal. One outer edge has a plurality of first slots, and another outer edge has a plurality of second slots. Both the first slots and second slots are extend from outer to inner of the body. The number of the first slots is different from the number of the second slots for controlling the shape of radiant filed of the radiant end.

### CROSS-REFERENCE TO RELATED APPLICATION(S)

This application claims priority to Taiwan Patent Application No. 100141302, filed on Oct. 11, 2011, and the disclosure of which is hereby incorporated by reference herein in its entirety.

### BACKGROUND

1. Field of the Inventions

The inventions described herein relate to an antenna module used in a portable device.

2. Description of the Related Art

The application of high speed transmission for full HD 1080p video such as WiGig, Wireless HD, etc. operating at frequency of 60 GHz and transmitting data at rate of 20 Gbit/s is considered to be the fourth generation of transmission module in mobile telecommunication, and adopted in the specification of IEEE 802.11ad for keeping pace with other system (i.e. 802.11(b, g, and n)). Since the signal in 60 GHz tends to be absorbed by Oxygen in atmosphere, the signal is merely transmitted in short distance (e.g. smaller than 10 m). Therefore, the radiation pattern and efficiency in the transmission device is very important that may affect the data transmission rate and the application environment.

A current 60 GHz antenna module (e.g. Silicon Image, Sony) uses an antenna array and a beam forming algorithm to achieve the purpose of high gain and tracing an object. However, it consumes large amounts of power to implement the algorithm, which is inappropriate for use in a general portable device.

Additionally, in applications involving wavelengths on the order of one millimeter, the thickness of the dielectric substrate is always greater than one-quarter wavelength of the operating frequency which results in a dielectric loss and low radiation efficiency.

Therefore, there is a need for an improved technology for providing an antenna module.

### SUMMARY

The present application describes an antenna unit, an antenna array, an antenna module, and an antenna system capable of forming radiation beams in different directions without any algorithm such that the power consumption is reduced and the arrangement of the antenna system in the portable device is not limited in area.

In one embodiment, an antenna unit in a portable device comprises a body which has a feeding end, a radiant end and two outer edges. The feeding end is configured to receive an input signal. One outer edge has a plurality of first slots, and another outer edge has a plurality of second slots. Both the first slots and the second slots are extended from outer to inner of the body. The number of the first slots is different from the number of the second slots for controlling the radiation pattern of the radiant end.

In another embodiment, an antenna array used in a portable device comprises a plurality of the antenna units. At least one antenna unit has a plurality of slots on the opposite edges of the antenna unit asymmetrically. The antenna units are in distribution arrangement.

In an alternate embodiment, an antenna module used in a portable device comprises a substrate and at least one antenna unit. The substrate includes a dielectric layer and a conductive layer. The dielectric layer is disposed on the conductive layer. The dielectric layer has a plurality of via holes extending from the conductive layer to the upper surface of the dielectric layer. The two opposite sides of the antenna unit have different numbers of slots.

At least one advantage of the inventions described herein is that the power consumption and the arrangement area may be reduced significantly.

The foregoing is a summary and should not be construed to limit the scope of the claims. The operations and devices disclosed herein may be implemented in a number of ways, and such changes and modifications may be made without departing from this scope. Other aspects, inventive features, and advantages as defined by the claims, are described in the non-limiting detailed description set forth below.

### BRIEF DESCRIPTION OF THE DRAWINGS

FIG. 1A is a schematic view illustrating an antenna unit used in a portable device;

FIG. 1B is a schematic view illustrating an antenna unit used in a portable device;

FIG. 2A is a schematic view illustrating an antenna array used in a portable device;

FIG. 2B is a radiation characteristic of the antenna array used in a portable device;

FIG. 3A is a cross section view illustrating an antenna module used in a portable; and

FIG. 3B is a schematic view illustrating an antenna system used in a portable device.

### DETAILED DESCRIPTION OF EMBODIMENTS

Reference will be made in detail to the examples of the inventions claimed herein, which are illustrated in the accompanying drawings. Wherever possible, the same reference numbers are used in the drawings and the description to refer to the same or like parts. In the drawings, the shape and thickness of one embodiment may be exaggerated for clarity and convenience. This description will be directed in particular to elements forming part of or cooperating more directly with apparatus described herein. It is to be understood that elements not specifically shown or described may take various forms well known to those skilled in the art.

The present application describes an antenna unit, an antenna array and an antenna module. It is worth noting that the antenna, the antenna array and the antenna module described herein may comprise other components. However, in order to simplify the figures and descriptions, only the basic and/or more important structures are depicted and described, and it is intended that such depictions and descriptions are not restrictive or limiting.

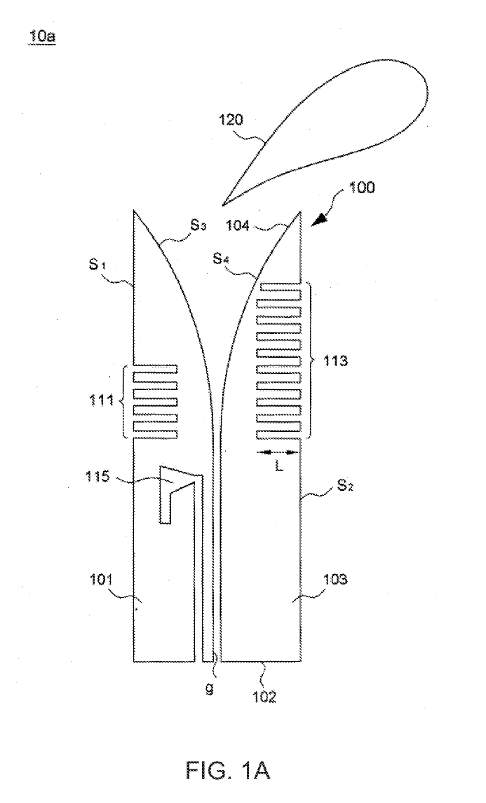

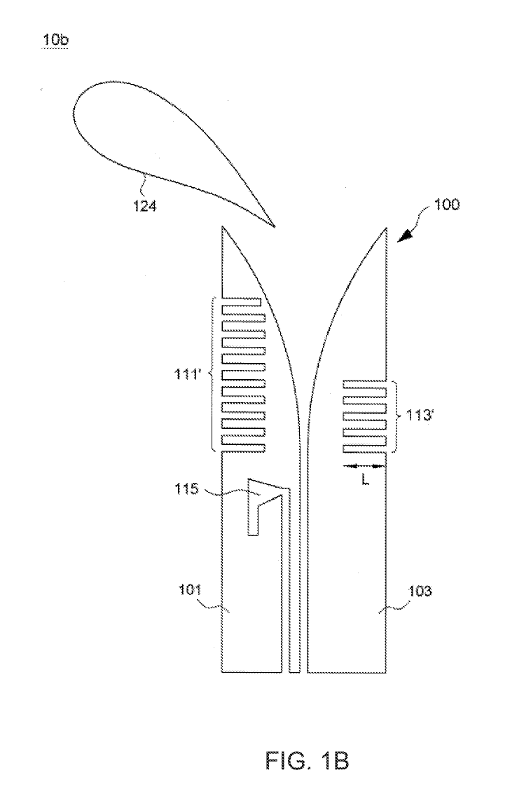

Referring to FIG. 1A, which is a schematic view illustrating an antenna unit used in a portable device in accordance with one embodiment. As shown in FIG. 1A, the structure of the antenna unit 10a is in a plate shape. The antenna unit 10a comprises a body 100 including a first conductor 101 and a second conductor 103 spaced apart from each other by a gap g. The body 100 has a feeding end 102 and a radiant end 104. A width of the gap g between the inner edge S₃ of the first conductor 101 and the inner edge S₄ of the second conductor 103 is gradually expanded from the feeding end 102 to the radiant end 104 such that the radiant ends 104 of the first conductor 101 and the second conductor 103 are divided in two branches. The contours of the first conductor 101 and the second conductor 103 are not restricted in the above-mentioned configuration.

The portable device (not shown) may be a tablet computer, a mobile phone or a personal digital assistant.

The outer edge S₁ of the first conductor 101 has a plurality of first slots 111 extending from outer to inner of the body 100. The outer edge S₂ of the second conductor 103 has a plurality of second slots 113 extending from outer to inner of the body 100. Moreover, the feeding end 102 of the first conductor 101 has a hook slot 115 extending from outer to inner of the body 100 for receiving an input signal (not shown). The first slots 111 are arranged in parallel and the second slots 113 are arranged in parallel.

One technical characteristic is that the radiation direction is controlled by adjusting the number ratio of the first slots 111 to the second slots 113. Specifically, the electric properties of the slots 111, 113 are regarded as short loads by looking from the inner of the slots 111, 113 to the outer of the body 100. In particular, different numbers of the first slots 111 and the second slots 113 may lead to different current path and phase. In other words, the numbers of the first slots 111 and the second slots 113 may be designed according to the desired radiation pattern. For example, if the number of the first slots 111 is smaller than the number of the second slots 113, the current of the outer edge S₂ of the second conductor 103 has a phase lag relative to the current of the outer edge S₁ of the first conductor 101. Thus, the radiation pattern 120 of the antenna unit 10a may be deviated to the right side (i.e. the position of the second conductor 103) as shown in FIG. 1A.

Similarly, referring to FIG. 1B, which is a schematic view illustrating an antenna unit used in a portable device, the antenna unit 10b has a first conductor 101 having a plurality of first slots 111′, and a second conductor 103 having a plurality of second slots 113′. The number of the first slots 111′ is greater than the number of the second slots 113′. As a result, the current of the outer edge S₁ of the first conductor 101 has a phase lag relative to the current of the outer edge S₂ of the second conductor 103. Thus, the radiation pattern 124 of the antenna unit 10b may be deviated to the left side (i.e. the position of the first conductor 101).

Specifically, the numbers of the slots 111, 113 of the antenna unit 10a and the numbers of the slots 111′, 113′ of the antenna unit 10b are designed in an asymmetrical manner to control the direction of the radiant beam into an asymmetrical radiation pattern.

Additionally, another technical characteristic is that the length L of the slots 111, 111′, 113, 113′ may be equal to one-quarter effective wavelength or an odd multiple of one-quarter effective wavelength (i.e.

$$L = \frac{1}{4} ( 2 N + 1 ) λ ,$$

where λ represents a effective wavelength, and N is greater than or equal to zero). Hence, the electric properties of the antenna units 10a, 10b are regarded as open loads by looking from the outer edges S₁, S₂ of the bodies 100 of the antenna units 10a, 10b to the inner side of the slots 111, 111′, 113, 113′. The slots 111, 111′, 113, 113′ may restrain stray coupling energy between the antenna units 10a, 10b, and may also reduce or restrain interference of the dielectric surface wave when the antenna units 10a, 10b are used at the same time. Hence, the antenna array with high gain and wide radiant beam may be constructed by the antenna units 10a, 10b. The following paragraphs describe an embodiment of the antenna array.

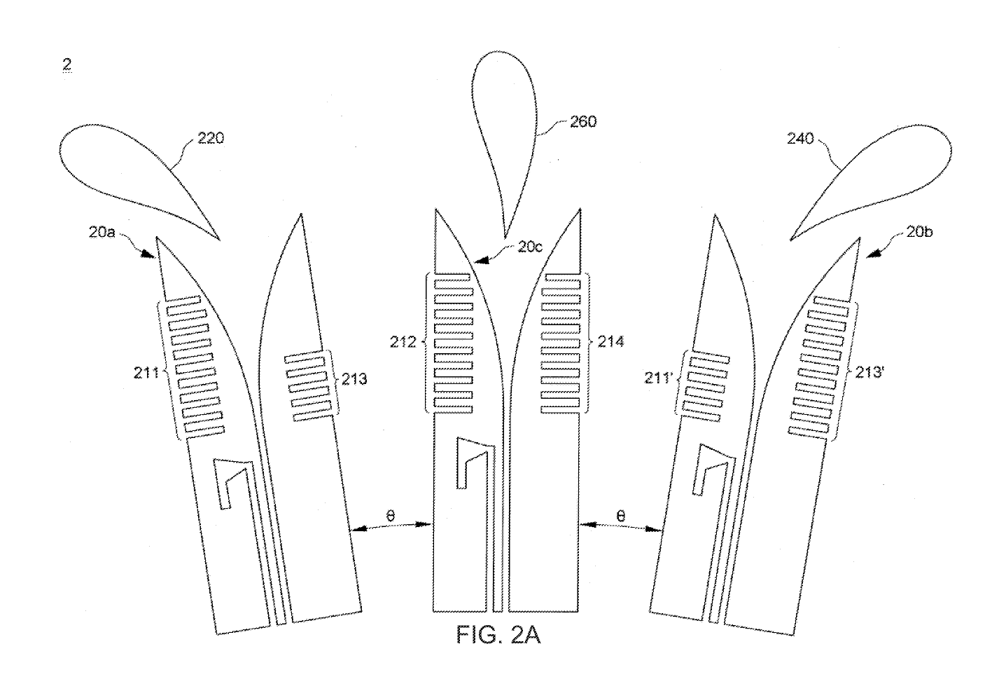

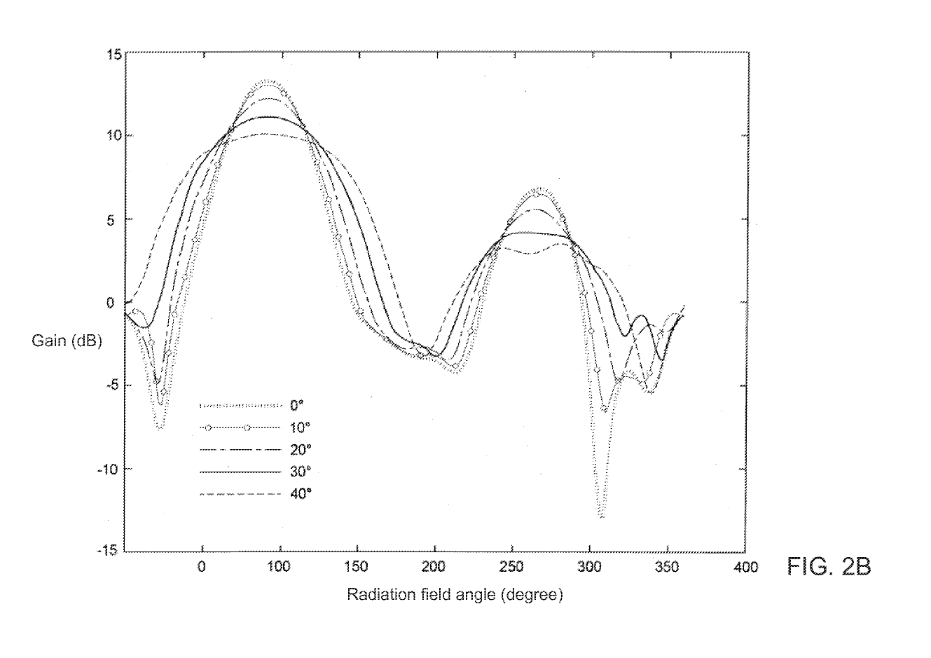

FIG. 2A is a schematic view illustrating an antenna array used in a portable device. As shown in FIG. 2A, antenna array 2 comprises a first antenna unit 20a, a second antenna unit 20b and a third antenna unit 20c. The antenna units 20a, 20b, 20c are spaced apart from one another, where the third antenna unit 20c is disposed between the first antenna unit 20a and the second antenna unit 20b. The opposite outer edges of the first antenna unit 20a have a plurality of asymmetric slots 211, 213; and the opposite outer edges of the second antenna unit 20b also have a plurality of asymmetric slots 211′, 213′. For example, a number of the first slots 211 is greater than a number of the second slots 213, such that the first antenna unit 20a may generate the radiation pattern 220 deviated to the left side of the first antenna unit 20a. A number of the first slots 211′ 20b is smaller than a number of the second slots 213′ such that the second antenna unit 20b may generate the radiation pattern 240 deviated to the right side of the second antenna unit 20b. The two outer sides of the third antenna unit 20c have asymmetric slots 212, 214 (i.e. a number of the first slots 212 is equal to a number of the second slots 214) such that the third antenna unit 20c may generate the symmetric radiation pattern 260. It is worth noting that the number of the antenna units 20a, 20b, 20c of the antenna array 2 is not restricted by the above-mentioned embodiment. The number of the antenna units may be equal to or greater than two, and the arrangement of the antenna units may be designed according to an actual desired radiation pattern.

In one embodiment, the antenna units 20a, 20b 20c are arranged in parallel or with a predetermined included angle θ. For example, the predetermined included angle θ may be between 0 through 45 degrees so as to accomplish the high gain and high coverage rate within 10 m over 90 degrees. Accordingly, the arrangement area of the antenna array 2 may be reduced to conform to the minimized desire of the electrical device.

FIG. 2B is a radiation characteristic of the antenna array used in a portable device. As shown in FIG. 2B, different pattern of radiation field may be formed by the antenna units 20a, 20b, 20c of the antenna array 2 arranged with different included angles: For example, the included angle may be equal to 0, 10, 20, 30, or 40 degrees.

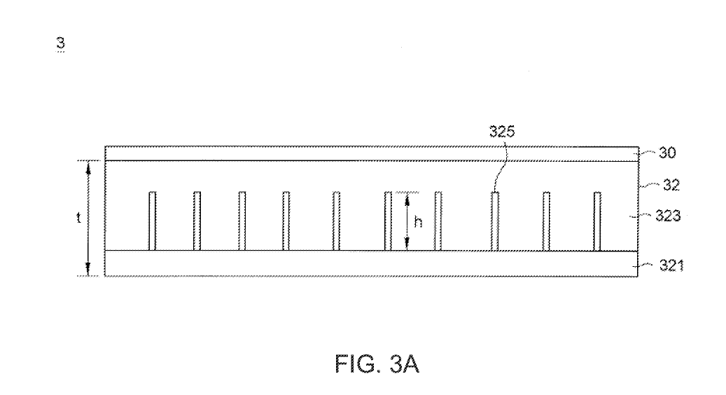

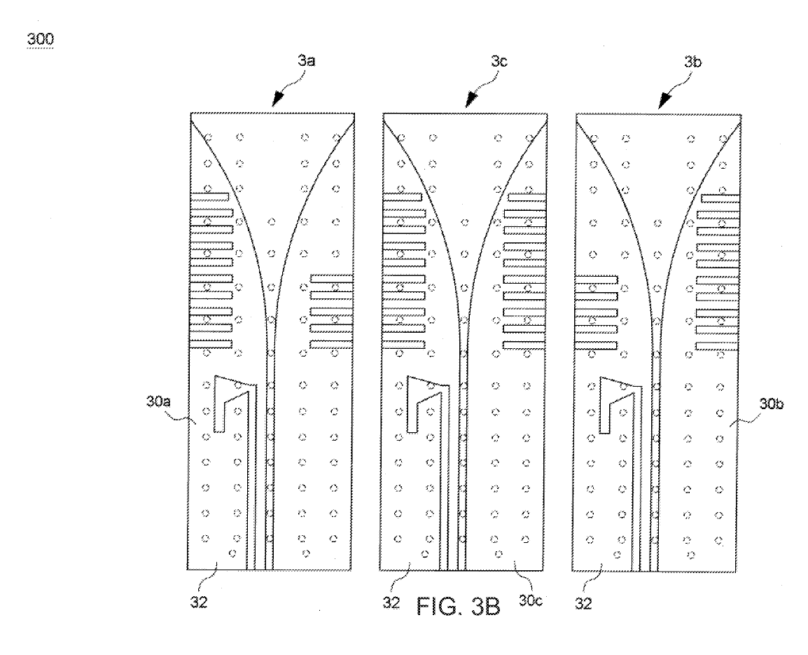

FIG. 3A is a cross section view illustrating an antenna module used in a portable device. As shown in FIG. 3A, the antenna module 3 may comprise a substrate 32 and at least one antenna unit 30 (e.g. at least one of the antenna units 20a, 20b, 20c of the antenna array 2). The antenna unit 30 is disposed on the substrate 32. The substrate 32 may comprise a conductive layer 321 and a dielectric layer 323 disposed on the conductive layer 321.

The thickness t of the substrate 32 may be greater than one-quarter effective wavelength. To prevent a dielectric loss, the dielectric layer 323 may have a plurality of via holes 325. The via holes 325 may be fabricated by a low temperature co-fired ceramic process. The via holes 325 are substantially a plurality of solid conducting cylinders spaced apart from one another by an equal distance. Each via hole 325 may extend from the conductive layer 321 to the upper surface of the dielectric layer 323 which is connected to the antenna unit 30. In particular, one end of each via hole 325 may be connected to the conductive layer 321. Accordingly, when an electromagnetic wave is transmitted from the upper surface to the lower surface of the dielectric layer 323, the via holes 325 are regarded as open loads and result from the approximately infinite dielectric resistance of the via holes 325. Hence, the electromagnetic wave may be incapable of penetrating the dielectric layer 323, and the via holes 325 are also regarded as magnetic walls.

The number and depth of the via holes 325 are not restricted by above-mentioned embodiment. Preferably, the depth h of each one of the via holes 325 may be equal to one-quarter effective wavelength or an odd multiple of one-quarter effective wavelength to suppress the spreading and scattering of the magnetic wave into the dielectric layer 323.

Finally, FIG. 3B is a schematic view illustrating an antenna system used in a portable device. As shown in FIG. 3B, the antenna system 300 may comprise the antenna modules 3a, 3b, 3c (similar to antenna module 3 in FIG. 3A). In practice, the number of the antenna modules may be at least two.

In one embodiment, the antenna units 30a, 30b, 30c of the antenna modules 3a, 3b, 3c may be disposed on the same substrate 32 or divided substrates 32. If the antenna units 30a, 30b, 30c are disposed on the divided substrates 32, the antenna modules 3a, 3b, 3c are spaced apart from one another in parallel or with a predetermined included angle. If the antenna units 30a, 30b, 30c are disposed on the same substrate 32, the antenna units 30a, 30b, 30c are spaced apart from one another in parallel or with a predetermined included angle. The radiation field with high gain and wide radiant beam may be formed by the antenna system 300 in both implementation manners.

Overall, the present application describes the antenna unit, the antenna array, the antenna module and the antenna system with asymmetric slots for controlling the radiation pattern without the beam forming algorithm. The radiation directivity and coverage rate may be preferably improved, and the dielectric loss is restrained effectively via the electromagnetic energy gap structure.

The embodiments discussed above are meant to be illustrative and not limiting. Many variations, modifications, additions, and improvements are possible. Accordingly, plural instances may be provided for components described herein as a single instance. Structures and functionality presented as discrete components in the exemplary configurations may be implemented as a combined structure or component. These and other variations, modifications, additions, and improvements may fall within the scope of the invention as defined in the claims that follow.

What is claimed is:

1. An antenna unit used in a portable device, comprising:
a body having a feeding end, a radiant end and two outer edges, wherein the feeding end is configured to receive an input signal having a wavelength, one outer edge has a plurality of first slots, the outer edge has a plurality of second slots, both the first slots and the second slots are extended from outer to inner of the body, and a number of the of the first slots is different from a number of the second slots for controlling the radiation pattern of the radiant end.

2. The antenna unit according to claim 1, wherein a length of each first slot and each second slot is equal to one-quarter effective wavelength or an odd multiple of one-quarter effective wavelength.

3. The antenna unit according to claim 1, wherein the body further comprises a first conductor and a second conductor, the first conductor is spaced apart from the second conductor by a gap, and the gap having a width that is gradually expanded from the feeding end to the radiant end.

4. The antenna unit according to claim 1, wherein the number of the first slots is greater than the number of the second slots.

5. The antenna unit according to claim 1, wherein the number of the first slots is smaller than the number of the second slots.

6. An antenna array used in a portable device, comprising a plurality of antenna units, wherein at least one of the antenna units has a plurality of slots on the opposite edges of the antenna unit asymmetrically, and the antenna units are in distribution arrangement.

7. The antenna array according to claim 6, wherein a length of each slot is equal to one-quarter effective wavelength or an odd multiple of one-quarter effective wavelength.

8. The antenna array according to claim 6, wherein the antenna units are arranged in parallel.

9. The antenna array according to claim 6, wherein the antenna units are arranged with a predetermined included angle.

10. The antenna array according to claim 9, wherein the predetermined included angle is between 0 degree and 45 degrees.

11. An antenna module used in a portable device, comprising:
a substrate including a dielectric layer and a conductive layer, wherein the dielectric layer is disposed on the conductive layer, and the dielectric layer has a plurality of via holes extending from the conductive layer to the upper surface of the dielectric layer; and
at least one antenna unit disposed on the dielectric layer, wherein the two opposite sides of the antenna unit have different number of slots.

12. The antenna module according to claim 11, wherein a thickness of the substrate is greater than one-quarter effective wavelength.

13. The antenna module according to claim 12, wherein a depth of each via hole is equal to one-quarter effective wavelength or an odd multiple of one-quarter effective wavelength.

14. The antenna module according to claim 13, wherein the via holes are spaced an equal distance apart from one anther.
